(19) United States
(12) Patent Application Publication
(10) Pub. No.: US 2018/0300524 A1
(43) Pub. Date: Oct. 18, 2018

(54) IMAGE CAPTURING MODULE AND MANUFACTURING METHOD THEREOF

(71) Applicant: Gingy Technology Inc., Hsinchu City (TW)

(72) Inventor: Kuo-Liang You, Hsinchu City (TW)

(73) Assignee: Gingy Technology Inc., Hsinchu City (TW)

(21) Appl. No.: 15/842,842

(22) Filed: Dec. 14, 2017

Related U.S. Application Data
(60) Provisional application No. 62/486,954, filed on Apr. 18, 2017.

(30) Foreign Application Priority Data
Sep. 12, 2017 (CN) 201710818193.5

(51) Int. Cl. G06K 9/00

(52) U.S. Cl. CPC G06K 9/0004

(57) ABSTRACT

An image capturing module including a light emitting element, a sensing element, a first circuit substrate, and a second circuit substrate is provided. The first circuit substrate includes a first substrate having a first through hole and a second through hole. The light emitting element is disposed in the first through hole. The sensing element is disposed in the second through hole. The second circuit substrate is disposed on a side of the first circuit substrate and includes a second substrate having a third through hole and a fourth through hole. The third through hole exposes a light emitting surface of the light emitting element disposed in the first through hole. The fourth through hole exposes a sensing surface of the sensing element disposed in the second through hole. A manufacturing method of the image capturing module is also provided.

### CROSS-REFERENCE TO RELATED APPLICATION

This application claims the priority benefit of U.S. provisional application Ser. No. 62/486,954, filed on Apr. 18, 2017 and China application serial no. 201710818193.5, filed on Sep. 12, 2017. The entirety of each of the above-mentioned patent applications is hereby incorporated by reference herein and made a part of this specification.

### BACKGROUND OF THE INVENTION

### Field of the Invention

The invention relates to an optical module and a manufacturing method thereof, and more particularly relates to an image capturing module and a manufacturing method thereof.

### Description of Related Art

Biometrics covers a wide range of characteristics, including the face, voice, iris, retina, vein, palmprint, fingerprint, and so on. Based on the sensing methods, biometric identification devices can be roughly categorized into optical type, capacitive type, ultrasonic type, and thermal induction type. Now, the optical biometric identification device has become the mainstream among biometrics technology. Therefore, how to enhance the competitiveness of optical biometric identification devices has become an important issue in this field.

### SUMMARY OF THE INVENTION

The invention provides an image capturing module that is thin and has good identification capability.

The invention provides a manufacturing method for manufacturing an image capturing module that is thin and has good identification capability.

An image capturing module of the invention includes a light emitting element, a sensing element, a first circuit substrate, and a second circuit substrate. The light emitting element provides a light beam that illuminates an object. The sensing element receives a portion of the light beam that is reflected by the object. The first circuit substrate includes a first substrate. The first substrate has a first through hole and a second through hole. The light emitting element is disposed in the first through hole. The sensing element is disposed in the second through hole. The second circuit substrate is disposed on a side of the first circuit substrate and includes a second substrate. The second substrate has a third through hole and a fourth through hole. The third through hole overlaps the first through hole and exposes a light emitting surface of the light emitting element disposed in the first through hole. The fourth through hole overlaps the second through hole and exposes a sensing surface of the sensing element disposed in the second through hole.

The invention provides a manufacturing method of an image capturing module, which includes the following. A first through hole and a second through hole are formed in a first substrate. A light emitting element is disposed in the first through hole. A sensing element is disposed in the second through hole. A third through hole and a fourth through hole are formed in a second substrate. The second substrate is disposed on a side of the first substrate, wherein the third through hole overlaps the first through hole and exposes a light emitting surface of the light emitting element disposed in the first through hole, and the fourth through hole overlaps the second through hole and exposes a sensing surface of the sensing element disposed in the second through hole.

Based on the above, in the image capturing module disclosed in the embodiments of the invention, the light emitting element and the sensing element are disposed in the through holes of the first substrate, which is conducive to reducing the overall thickness of the image capturing module. In addition, since the first substrate is formed with the through holes and the light emitting element and the sensing element are respectively disposed in the through holes of the first substrate, the light emitting element and the sensing element are separated by a partition wall, which effectively prevents light interference caused by direct exposure of the sensing element to a large-angle light beam from the light emitting element, so as to improve the identification capability of the image capturing module. Thus, the image capturing module is thin and has good identification capability. A manufacturing method of the image capturing module is also provided.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic cross-sectional view of an image capturing module according to the first embodiment of the invention.

FIG. 1B is a schematic top view of an image capturing module according to the first embodiment of the invention.

FIG. 2A to FIG. 2G are schematic cross-sectional views showing a manufacturing method of the image capturing module according to the first embodiment of the invention.

FIG. 3 and FIG. 4 are schematic cross-sectional views of the image capturing modules according to the second and the third embodiments of the invention.

### DESCRIPTION OF THE EMBODIMENTS

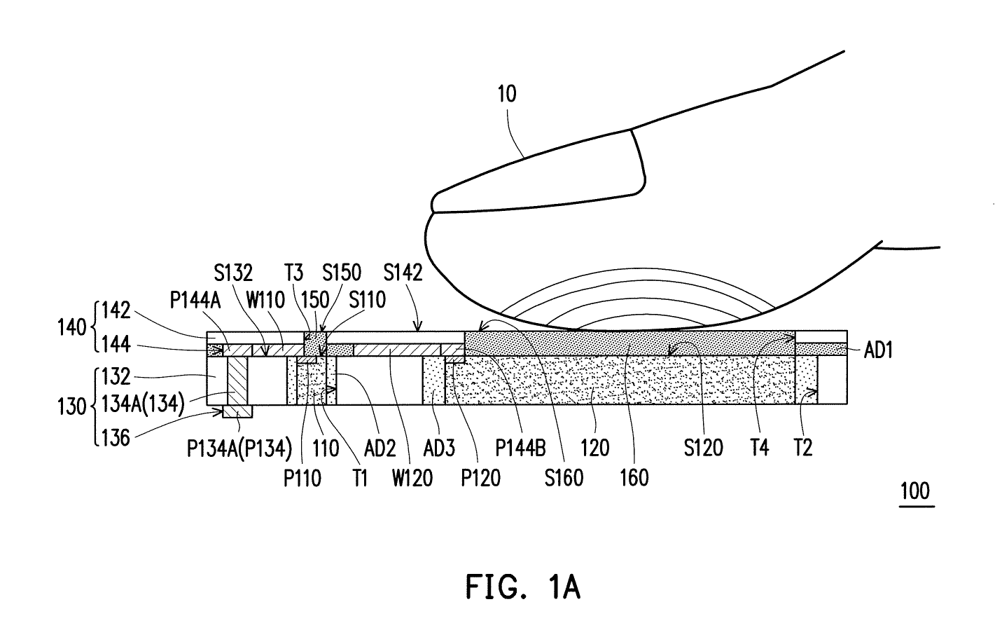

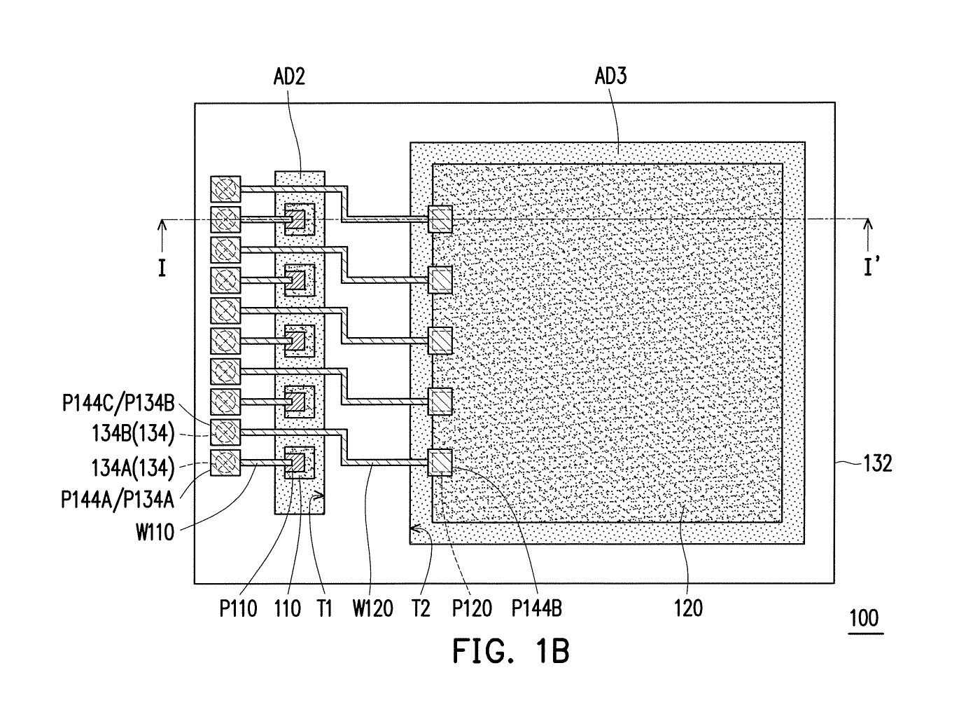

FIG. 1A is a schematic cross-sectional view of an image capturing module according to the first embodiment of the invention, and FIG. 1B is a schematic top view of an image capturing module according to the first embodiment of the invention. FIG. 1A is a schematic cross-sectional view corresponding to the section line I-I′ in FIG. 1B, for example. Moreover, the second substrate, the first adhesive layer, the first translucent protective layer, and the second translucent protective layer of FIG. 1A are not depicted in FIG. 1B, so as to clearly show the relative positional relationship between the elements under these layers in FIG. 1B.

Referring to FIG. 1A and FIG. 1B, an image capturing module 100 of the first embodiment is adapted for acquiring a biological characteristic of an object 10. In this exemplary embodiment, the object 10 is a finger, and the biological characteristic is a fingerprint or vein, for example, but not limited thereto. In another exemplary embodiment, the object 10 may be a palm, and the biological characteristic may be a palmprint.

The image capturing module 100 includes a light emitting element 110, a sensing element 120, a first circuit substrate 130, and a second circuit substrate 140.

The light emitting element 110 provides a light beam (not shown) to illuminate the object 10. To meet different requirements, the image capturing module 100 may include one or more light emitting elements 110. In this exemplary embodiment, as shown in FIG. 1B, the image capturing module 100 includes a plurality of the light emitting elements 110 (five light emitting elements 110, for example), and the light emitting elements 110 are arranged on the same side of the sensing element 120. Nevertheless, the number of the light emitting elements 110 and the relative positional relationship between the light emitting elements 110 and the sensing element 120 may be changed as required and thus are not limited to the disclosure of FIG. 1B.

The light emitting elements 110 may include light emitting diodes, laser diodes, or a combination of the foregoing. In addition, the light beam may include a visible light, an invisible light, or a combination of the foregoing. The invisible light may be infrared light, but not limited thereto.

The sensing element 120 receives a portion of the light beam that is reflected by the object 10 (i.e., a reflected light beam with fingerprint pattern information), so as to identify the biological characteristic of the object 10. The sensing element 120 may be a charge coupled device (CCD), a complementary metal-oxide semiconductor (CMOS) device, or other suitable image sensing devices.

In an exemplary embodiment, the sensing element 120 may incorporate a pulse width modulation circuit therein. The pulse width modulation circuit controls light emitting times of the light emitting elements 110 and an image capturing time of the sensing element 120, so as to synchronize the light emitting times of the light emitting elements 110 and the image capturing time of the sensing element 120 to achieve precise control, but the invention is not limited thereto.

The first circuit substrate 130 includes a first substrate 132. The first substrate 132 may be a single layer substrate or a multilayer substrate. Moreover, the first substrate 132 may include a circuit. For example, the first substrate 132 may be a printed circuit board (PCB), a flexible printed circuit board (FPCB), a glass carrier with a circuit, or a ceramic substrate with a circuit, but not limited thereto.

The first substrate 132 has a first through hole T1 and a second through hole T2. The light emitting elements 110 are disposed in the first through hole T1. The sensing element 120 is disposed in the second through hole T2. In this exemplary embodiment, a light emitting surface 5110 of each light emitting element 110 and a surface S132 of the first substrate 132, which faces the second circuit substrate 140, are on the same plane, and a sensing surface S120 of the sensing element 120 and the surface S132 of the first substrate 132, which faces the second circuit substrate 140, are on the same plane, but the invention is not limited thereto. To meet different requirements, the light emitting surface S110 of each light emitting element 110 may be higher or lower than the surface S132 of the first substrate 132, and the sensing surface S120 of the sensing element 120 may also be higher or lower than the surface S132 of the first substrate 132.

To meet different requirements, the first circuit substrate 130 may further include other elements. For example, the first circuit substrate 130 may further include a plurality of conductive columns 134 and a first circuit layer 136. The conductive columns 134 respectively penetrate the first substrate 132 to electrically connect the circuits located on the opposite sides of the first substrate 132. The first circuit layer 136 is located on a side of the first substrate 132, which is away from the second circuit substrate 140, and is electrically connected with the conductive columns 134. For example, the first circuit layer 136 may include a plurality of conductive pads P134 (including a plurality of first conductive pads P134A and a plurality of second conductive pads P134B) connected with the conductive columns 134 (including a plurality of first conductive columns 134A and a plurality of second conductive columns 134B) and other wires and conductive pads that are not shown. In another exemplary embodiment, the first circuit substrate 130 may further include another circuit layer that is not shown. The circuit layer may be located on a side of the first substrate 132, which faces the second circuit substrate 140, and the circuit layer may include a plurality of conductive pads, which are connected with the conductive columns 134 and opposite to the first conductive pads P134, and other wires and conductive pads that are not shown.

The second circuit substrate 140 is disposed on a side of the first circuit substrate 130. For example, the second circuit substrate 140 is disposed on the light emitting surface S110 of each light emitting element 110, the sensing surface S120 of the sensing element 120, and the surface S132 of the first substrate 132, which faces the second circuit substrate 140.

The second circuit substrate 140 includes a second substrate 142. The second substrate 142 may be a single layer substrate or a multilayer substrate. In addition, the second substrate 142 may include a circuit. For example, the second substrate 142 may be a printed circuit board (PCB), a flexible printed circuit board (FPCB), a glass carrier with a circuit, or a ceramic substrate with a circuit, but not limited thereto. In an exemplary embodiment, the second substrate 142 may be a translucent substrate that does not include a circuit.

The second substrate 142 has a third through hole T3 and a fourth through hole T4. The third through hole T3 and the fourth through hole T4 are adapted to allow the light beam to pass through. The third through hole T3 overlaps the first through hole T1 and exposes the light emitting surface S110 of each light emitting element 110 disposed in the first through hole T1. The fourth through hole T4 overlaps the second through hole T2 and exposes the sensing surface S120 of the sensing element 120 disposed in the second through hole T2. Thus, the light beam from each light emitting element 110 may illuminate the object 10 via the third through hole T3, and the portion of the light beam that is reflected by the object 10 may be received by the sensing element 120 via the fourth through hole T4. In this exemplary embodiment, one third through hole T3 and one fourth through hole T4 are formed, but the invention is not limited thereto. For example, the second substrate 142 may have a plurality of the third through holes T3, and the third through holes T3 may be respectively disposed above the light emitting elements 110, but not limited thereto.

To meet different requirements, the second circuit substrate 140 may further include other elements. For example, the second circuit substrate 140 may further include a second circuit layer 144. The second circuit layer 144 is located between the second substrate 142 and the first circuit substrate 130 and is electrically connected with the first circuit layer 136 via the conductive columns 134.

In this exemplary embodiment, the conductive pads P110 of the light emitting elements 110 are located on a side of the light emitting elements 110 that faces the second circuit substrate 140, and the conductive pads P120 of the sensing element 120 are located on a side of the sensing element 120 that faces the second circuit substrate 140. Moreover, the conductive pads P110 of the light emitting elements 110 (or the conductive pads P120 of the sensing element 120) are electrically connected with the first circuit layer 136 via the second circuit layer 144 and the first conductive columns 134A (or the second conductive columns 134B) of the conductive columns 134.

As shown in FIG. 1B, the second circuit layer 144 may include a plurality of conductive wires W110 electrically connected with the conductive pads P110 of the light emitting elements 110, a plurality of conductive pads P144A electrically connected with the conductive wires W110, a plurality of conductive pads P144B electrically connected with the conductive pads P120 of the sensing element 120, a plurality of conductive wires W120 electrically connected with the conductive pads P144B, a plurality of conductive pads P144C electrically connected with the conductive wires W120, and other conductive wires and conductive pads that are not shown. The conductive pad P110 of each light emitting element 110 is electrically connected with one corresponding first conductive pad P134A of the first circuit layer 136 via one corresponding conductive wire W110 of the second circuit layer 144, one conductive pad P144A electrically connected with the conductive wire W110, and one first conductive column 134A electrically connected with the conductive pad P144A. Moreover, each conductive pad P120 of the sensing element 120 is electrically connected with one corresponding second conductive pad P134B of the first circuit layer 136 via one corresponding conductive pad P144B of the second circuit layer 144, one conductive wire W120 electrically connected with the conductive pad P144B, one conductive pad P144C electrically connected with the conductive wire W120, and one second conductive column 134B electrically connected with the conductive pad P144C.

In another exemplary embodiment, the second circuit layer 144 may further include a plurality of conductive pads that are not shown. The conductive pads are located above the conductive pads P110 of the light emitting elements 110, and each conductive pad is electrically connected with the conductive pad P110 of one corresponding light emitting element 110 and one corresponding conductive wire W110.

To meet different requirements, the image capturing module 100 may further include other layers. For example, the image capturing module 100 may further include a first adhesive layer AD1, a second adhesive layer AD2, and a third adhesive layer AD3. The first adhesive layer AD1 is filled in a gap among the first substrate 132, the second substrate 142, and the second circuit layer 144. The first circuit substrate 130 and the second circuit substrate 140 are bonded to each other via the first adhesive layer AD1. The second adhesive layer AD2 is disposed in the first through hole T1, and the light emitting element 110 is fixed in the first through hole T1 of the first substrate 132 via the second adhesive layer AD2. The third adhesive layer AD3 is disposed in the second through hole T2, and the sensing element 120 is fixed in the second through hole T2 of the first substrate 132 via the third adhesive layer AD3.

The first adhesive layer AD1, the second adhesive layer AD2, and the third adhesive layer AD3 may be thermal curing or photo-curing colloid. Moreover, the first adhesive layer AD1, the second adhesive layer AD2, and the third adhesive layer AD3 may be translucent or non-translucent adhesive layers.

In another exemplary embodiment, the first circuit substrate 130 and the second circuit substrate 140 may be fixed together by other means without the first adhesive layer AD1. In addition, the light emitting element 110 may be fixed in the first through hole T1 of the first substrate 132 by other means without the second adhesive layer AD2. Furthermore, the sensing element 120 may be fixed in the second through hole T2 of the first substrate 132 by other means without the third adhesive layer AD3.

The image capturing module 100 may further include a first translucent protective layer 150 and a second translucent protective layer 160. The first translucent protective layer 150 is disposed in the third through hole T3 and covers the light emitting surface S110 of the light emitting element 110 to protect the light emitting element 110 (prevent the light emitting surface S110 of the light emitting element 110 from being scratched, for example). The second translucent protective layer 160 is disposed in the fourth through hole T4 and covers the sensing surface S120 of the sensing element 120 to protect the sensing element 120 (prevent the sensing surface S120 of the sensing element 120 from being scratched, for example). For example, the first translucent protective layer 150 and the second translucent protective layer 160 may be formed by curing a thermal curing or photo-curing translucent colloid, but not limited thereto. In addition, the first translucent protective layer 150 and the second translucent protective layer 160 may be formed of the same or different materials.

In addition to providing protection, the first translucent protective layer 150 and the second translucent protective layer 160 may fill where the third through hole T3 and the fourth through hole T4 are formed, so as to put a surface S150 of the first translucent protective layer 150 that is away from the light emitting surface S110, a surface S160 of the second translucent protective layer 160 that is away from the sensing surface S120, and the surface S142 of the second substrate 142 that is away from the first circuit substrate 130 on the same plane. Thus, the entire pressing surface (the surface to be in contact with the object 10) of the structure is flat, so as to facilitate combining the image capturing module 100 with other electronic devices.

Disposing the light emitting elements 110 and the sensing element 120 in the through holes (including the first through hole T1 and the second through hole T2) of the first substrate 132 and forming the required circuit on the opposite side of the first substrate 132 is conducive to reducing the overall thickness of the image capturing module 100, as compared with disposing the light emitting elements 110 and the sensing element 120 on the first substrate 132 and then electrically connecting the light emitting elements 110 and the sensing element 120 with the first substrate 132 by a wire bonding process. In addition, since the first substrate 132 is formed with the through holes and the light emitting elements 110 and the sensing element 120 are respectively disposed in the through holes of the first substrate 132, naturally the light emitting elements 110 and the sensing element 120 are separated by a partition wall. Accordingly, it is not required to dispose an additional light shielding element between the light emitting elements 110 and the sensing element 120. In other words, the light interference caused by direct exposure of the sensing element 120 to a large-angle light beam from the light emitting elements 110 can be prevented effectively to improve the identification capability of the image capturing module 100. Thus, the image capturing module 100 is thin and has good identification capability.

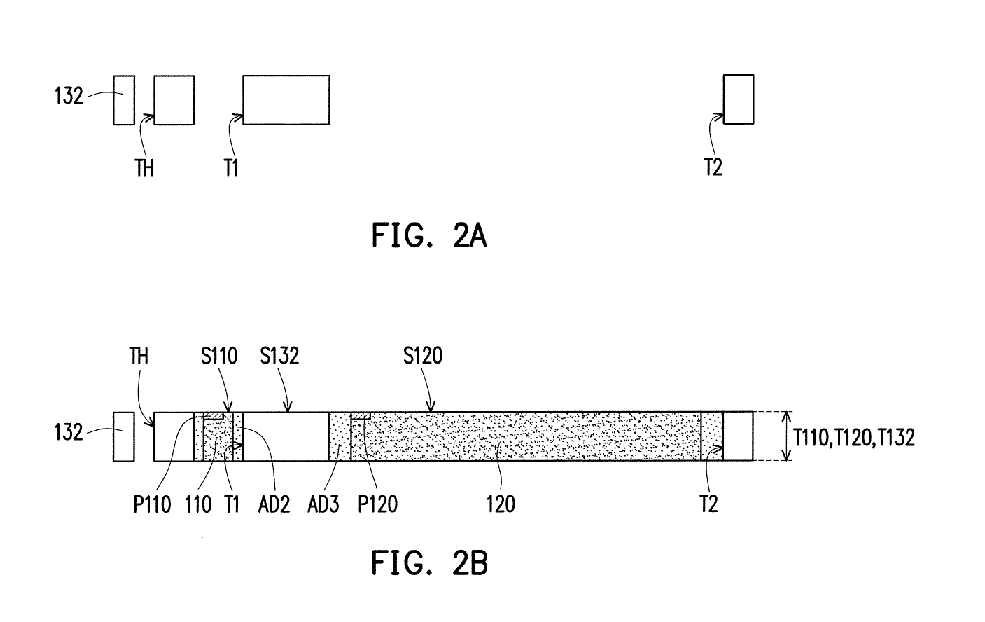

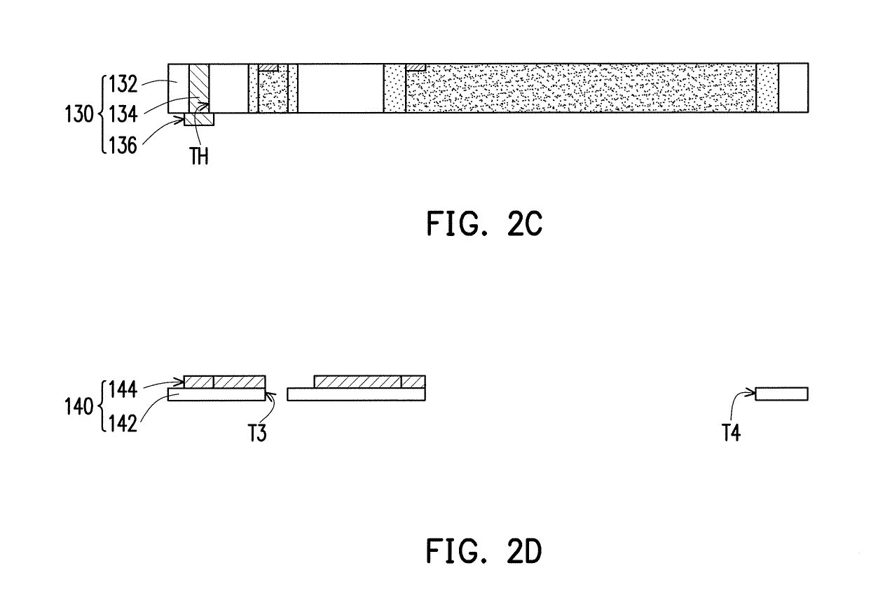

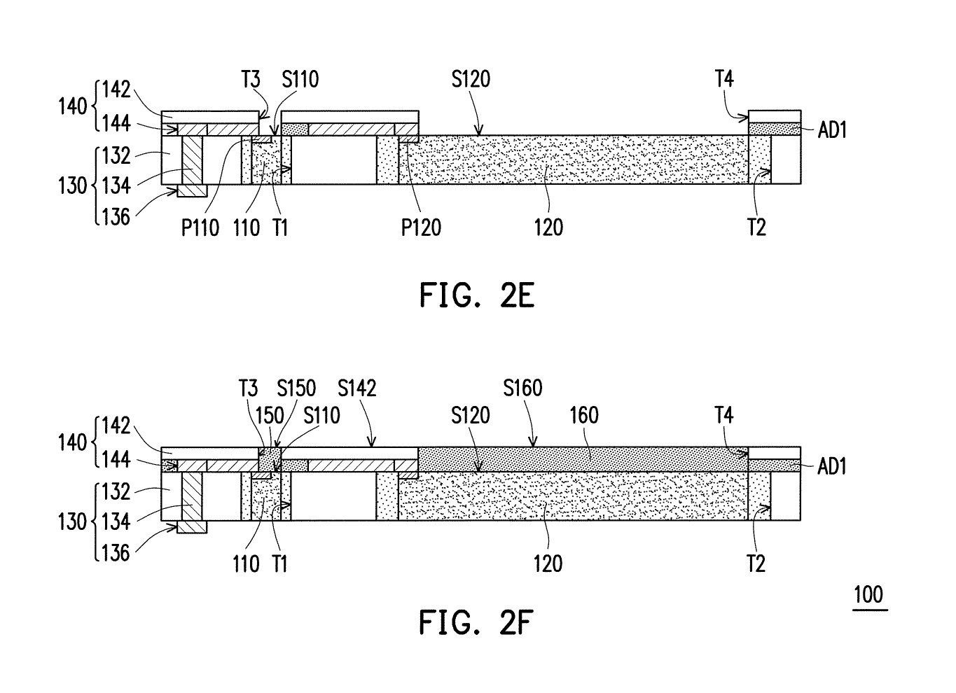

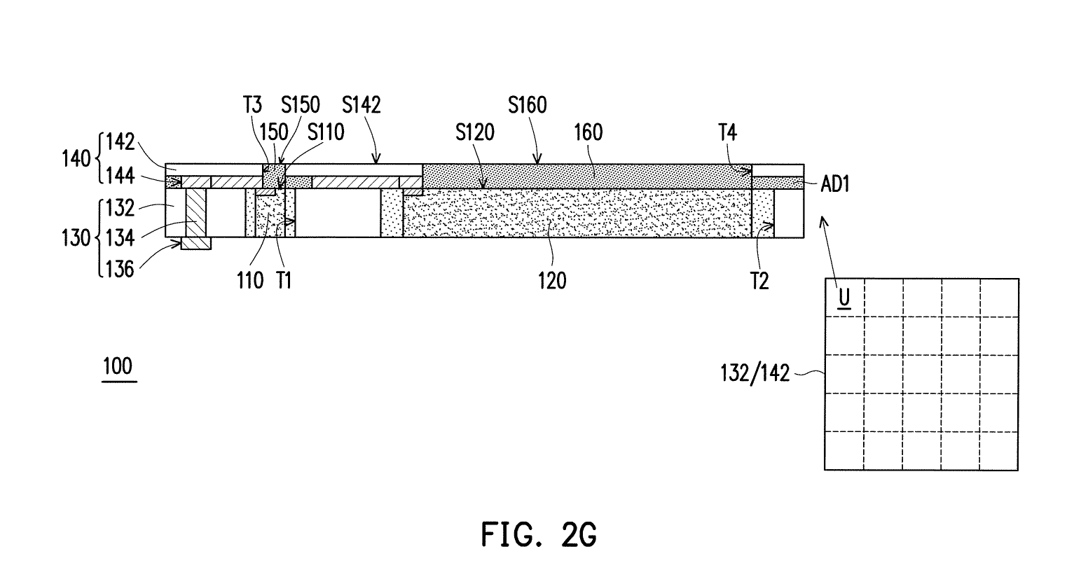

FIG. 2A to FIG. 2G are schematic cross-sectional views showing a manufacturing method of the image capturing module according to the first embodiment of the invention. Nevertheless, it should be noted that the manufacturing method of the image capturing module 100 of FIG. 1A and FIG. 1B is not limited to the disclosure of FIG. 2A to FIG. 2G.

Referring to FIG. 2A, first, a first substrate 132 is provided, and a first through hole T1 for disposing a light emitting element and a second through hole T2 for disposing a sensing element are formed in the first substrate 132. In this step, a through hole TH for accommodating a conductive column may be formed at the same time.

Referring to FIG. 2B, the light emitting element 110 is disposed in the first through hole T1, and a sensing element 120 is disposed in the second through hole T2. In this exemplary embodiment, a method of disposing the light emitting element 110 in the first through hole T1 includes fixing the light emitting element 110 in the first through hole T1 of the first substrate 132 via a second adhesive layer AD2, and a method of disposing the sensing element 120 in the second through hole T2 includes fixing the sensing element 120 in the second through hole T2 of the first substrate 132 via a third adhesive layer AD3, but the invention is not limited thereto. In another exemplary embodiment, the light emitting element 110 may be fixed in the first through hole T1 of the first substrate 132 by other means without the second adhesive layer AD2. Likewise, the sensing element 120 may be fixed in the second through hole T2 of the first substrate 132 by other means without the third adhesive layer AD3.

Moreover, a method of disposing the light emitting element 110 in the first through hole T1 and disposing the sensing element 120 in the second through hole T2 includes arranging a conductive pad P110 of the light emitting element 110 and a conductive pad P120 of the sensing element 120 to face a side of the first substrate 132 where a second substrate 142 is to be disposed.

Moreover, before disposing the light emitting element 110 in the first through hole T1 and disposing the sensing element 120 in the second through hole T2, a polishing process may be performed on the light emitting element 110 and the sensing element 120, such that a thickness T110 of the light emitting element 110 is equal to a thickness T132 of the first substrate 132 and a thickness T120 of the sensing element 120 is equal to the thickness T132 of the first substrate 132. Thus, after the light emitting element 110 and the sensing element 120 are disposed in the first through hole T1 and the second through hole T2, a light emitting surface S110 of the light emitting element 110, a sensing surface S120 of the sensing element 120, and the surface S132 of the first substrate 132 are on the same plane, but the invention is not limited thereto. To meet different requirements, the light emitting surface S110 of the light emitting element 110 may be higher or lower than the surface S132 of the first substrate 132, and the sensing surface S120 of the sensing element 120 may also be higher or lower than the surface S132 of the first substrate 132. Otherwise, in a case where the thickness T110 of the light emitting element 110 and the thickness T120 of the sensing element 120 are the preset values, the polishing process may be omitted.

Referring to FIG. 2C, a conductive column 134 is formed in the first substrate 132, and a first circuit layer 136 electrically connected with the conductive column 134 is formed on a side of the first substrate 132. A method of forming the conductive column 134 in the first substrate 132 may include filling the through hole TH of the first substrate 132 with a conductive material. The first circuit layer 136 is a patterned conductive layer, and the elements included therein have been specified in the corresponding paragraphs above and thus are not repeated hereinafter. In an exemplary embodiment, the steps of FIG. 2B and FIG. 2C may be performed in a reverse order. That is, the conductive column 134 and the first circuit layer 136 may be formed first, and then the light emitting element 110 and the sensing element 120 are disposed in the first substrate 132.

Referring to FIG. 2D, the second substrate 142 is provided, and a third through hole T3 and a fourth through hole T4 are formed in the second substrate 142. Further, a second circuit layer 144 is formed on a side of the second substrate 142. The second circuit layer 144 is a patterned conductive layer, and the elements included therein have been specified in the corresponding paragraphs above and thus are not repeated hereinafter. In an exemplary embodiment, the step of FIG. 2D may be performed before the steps of FIG. 2A to FIG. 2C are performed. That is, the second circuit substrate 140 is manufactured first and then the first circuit substrate 130 is manufactured.

Referring to FIG. 2E, the second circuit substrate 140 is inverted and disposed on a side of the first substrate 132, such that the second circuit layer 144 is located between the second substrate 142 and the first substrate 132, and the first substrate 132 is located between the first circuit layer 136 and the second circuit layer 144. In this exemplary embodiment, a method of disposing the second substrate 142 on the side of the first substrate 132 includes bonding the first substrate 132 and the second substrate 142 via a first adhesive layer AD1. The first adhesive layer AD1 is filled into a gap among the first substrate 132, the second substrate 142, and the second circuit layer 144 by underfill, for example, but the invention is not limited thereto.

After the second substrate 142 is disposed on the side of the first substrate 132, the third through hole T3 overlaps the first through hole T1 and exposes the light emitting surface S110 of the light emitting element 110 disposed in the first through hole T1, and the fourth through hole T4 overlaps the second through hole T2 and exposes the sensing surface S120 of the sensing element 120 disposed in the second through hole T2.

In addition, the second circuit layer 144 is electrically connected with the first circuit layer 136 via the conductive column 134. Furthermore, the conductive pad P110 of the light emitting element 110 is electrically connected with the first circuit layer 136 via the second circuit layer 144 and the first conductive column 134A (refer to FIG. 1B) of the conductive columns 134, and the conductive pad P120 of the sensing element 120 is electrically connected with the first circuit layer 136 via the second circuit layer 144 and the second conductive column 134B (refer to FIG. 1B) of the conductive columns 134.

In an exemplary embodiment, before the first circuit substrate 130 and the second circuit substrate 140 are bonded, solder balls (not shown) may be respectively implanted on the conductive pad P110 of the light emitting element 110 and the conductive pad P120 of the sensing element 120, and then the solder balls on the conductive pad P110 and the conductive pad P120 are electrically connected with the corresponding circuits in the second circuit layer 144 respectively, but the invention is not limited thereto.

Referring to FIG. 2F, a first translucent protective layer 150 is disposed in the third through hole T3, and a second translucent protective layer 160 is disposed in the fourth through hole T4, wherein the first translucent protective layer 150 covers the light emitting surface S110 of the light emitting element 110 and the second translucent protective layer 160 covers the sensing surface S120 of the sensing element 120. In this exemplary embodiment, the first translucent protective layer 150 and the second translucent protective layer 160 are for example formed in the third through hole T3 and the fourth through hole T4 by applying a translucent material and then curing the translucent material by a thermal curing or photo-curing process, but the invention is not limited thereto.

A surface S150 of the first translucent protective layer 150 that is away from the light emitting surface S110, a surface S160 of the second translucent protective layer 160 that is away from the sensing surface S120, and the surface S142 of the second substrate 142 that is away from the first circuit substrate 130 may be on the same plane, but the invention is not limited thereto. In another exemplary embodiment, the translucent material may further cover the surface S142 of the second substrate 142. The above also forms a structure that the entire pressing surface (the surface to be in contact with the object) is flat.

By performing the steps described above, the image capturing module 100 is basically completed. In an exemplary embodiment, as shown in FIG. 2G, a plurality of image capturing units U may be manufactured simultaneously in the first substrate 132 and the second substrate 142 to be cut into a plurality of the image capturing modules 100 by a cutting process (along the dotted lines of FIG. 2G).

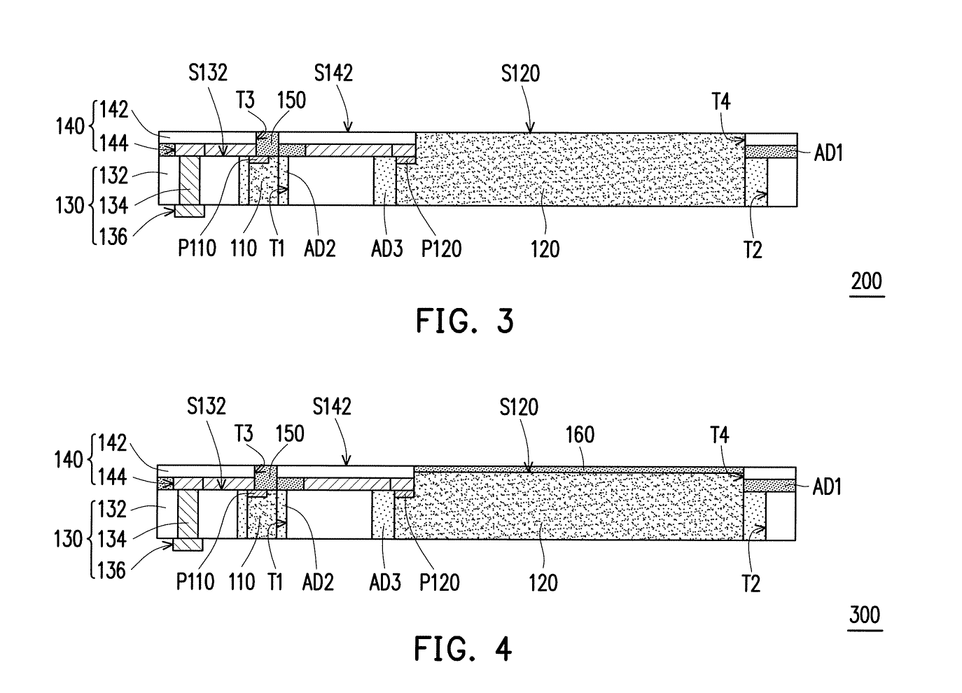

FIG. 3 and FIG. 4 are schematic cross-sectional views of the image capturing modules according to the second and the third embodiments of the invention. Referring to FIG. 3, an image capturing module 200 of the second embodiment is similar to the image capturing module 100 of FIG. 1A and FIG. 1B, wherein the same elements are denoted by the same reference numerals, and thus the materials, relative positional relationship, manufacturing methods, and functions thereof are not repeated hereinafter.

A main difference between the image capturing module 200 and the image capturing module 100 is as follows. In the image capturing module 200, the sensing surface S120 of the sensing element 120 and the surface S142 of the second substrate 142 that is away from the first circuit substrate 130 are on the same plane. In addition, the second translucent protective layer 160 of FIG. 1A is omitted from the image capturing module 200.

By putting the sensing surface S120 of the sensing element 120 and the surface S142 of the second substrate 142 that is away from the first circuit substrate 130 on the same plane, the sensing surface S120 can be closer to the object (the object can even press directly on the sensing surface S120), so as to enhance the image. With this configuration, the step of reducing the thickness of the sensing element 120 in FIG. 2B may be omitted or the time for reducing the thickness of the sensing element 120 may be shortened, and thus the time for manufacturing the image capturing module 200 is shortened.

In an exemplary embodiment, the second translucent protective layer 160 of FIG. 1A may be formed on the sensing surface S120 of the sensing element 120 to protect the sensing element 120.

Referring to FIG. 4, an image capturing module 300 of the third embodiment is similar to the image capturing module 200 of FIG. 3, wherein the same elements are denoted by the same reference numerals, and thus the materials, relative positional relationship, manufacturing methods, and functions thereof are not repeated hereinafter.

A main difference between the image capturing module 300 and the image capturing module 200 is as follows. In the image capturing module 300, the sensing surface S120 of the sensing element 120 is higher than the surface S132 of the first substrate 132 that faces the second circuit substrate 140 and lower than the surface S142 of the second substrate 142 that is away from the first circuit substrate 130. Moreover, the image capturing module 300 includes the second translucent protective layer 160 that is disposed on the sensing surface S120 of the sensing element 120 to protect the sensing element 120. Thus, the image capturing module 300 achieves the effects of enhancing the image and protecting the sensing element 120 as well as shortens the time for reducing the thickness of the sensing element 120 in FIG. 2B.

To sum up, in the image capturing module disclosed in the embodiments of the invention, the light emitting element and the sensing element are disposed in the through holes of the first substrate, which is conducive to reducing the overall thickness of the image capturing module. In addition, since the first substrate is formed with the through holes and the light emitting element and the sensing element are respectively disposed in the through holes of the first substrate, the light emitting element and the sensing element are separated by a partition wall, which effectively prevents light interference caused by direct exposure of the sensing element to a large-angle light beam from the light emitting element, so as to improve the identification capability of the image capturing module. Thus, the image capturing module is thin and has good identification capability. In an exemplary embodiment, where the through hole is formed is filled by the translucent protective layer. Thus, the entire pressing surface of the structure is flat, so as to facilitate combining the image capturing module with other electronic devices. In another exemplary embodiment, the distance between the sensing surface of the sensing element and the object is shortened, so as to enhance the image. Furthermore, in the manufacturing method of the image capturing module disclosed in the embodiments of the invention, before the adhesive layer for fixing the first substrate and the second substrate is filled, the light emitting element and the sensing element have already been fixed in the through holes of the first substrate, and the related circuits have been formed and electrically connected with the light emitting element and the sensing element by press bonding. Thus, when the adhesive layer for fixing the first substrate and the second substrate is filled, the light emitting element, the sensing element, and the related circuits do not move or break easily. Moreover, since it is not required to form an additional light shielding element between the light emitting element and the sensing element, the manufacturing time and costs are lowered. In an exemplary embodiment, the step of thinning the sensing element may be omitted or the time for reducing the thickness of the sensing element may be shortened.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. An image capturing module, comprising:
a light emitting element providing a light beam that illuminates an object;
a sensing element receiving a portion of the light beam that is reflected by the object;
a first circuit substrate comprising a first substrate having a first through hole and a second through hole, wherein the light emitting element is disposed in the first through hole and the sensing element is disposed in the second through hole; and
a second circuit substrate disposed on a side of the first circuit substrate and comprising a second substrate having a third through hole and a fourth through hole, wherein the third through hole overlaps the first through hole and exposes a light emitting surface of the light emitting element disposed in the first through hole, and the fourth through hole overlaps the second through hole and exposes a sensing surface of the sensing element disposed in the second through hole.

2. The image capturing module according to claim 1, wherein at least one of the first substrate and the second substrate is a multilayer substrate.

3. The image capturing module according to claim 1, wherein the light emitting surface of the light emitting element and a surface of the first substrate that faces the second circuit substrate are on the same plane.

4. The image capturing module according to claim 1, wherein the sensing surface of the sensing element and a surface of the first substrate that faces the second circuit substrate are on the same plane.

5. The image capturing module according to claim 1, wherein the sensing surface of the sensing element and a surface of the second substrate that is away from the first circuit substrate are on the same plane, or the sensing surface of the sensing element is higher than a surface of the first substrate that faces the second circuit substrate and lower than the surface of the second substrate that is away from the first circuit substrate.

6. The image capturing module according to claim 1, further comprising:
a first adhesive layer, wherein the first circuit substrate and the second circuit substrate are bonded to each other via the first adhesive layer.

7. The image capturing module according to claim 1, further comprising:
a second adhesive layer disposed in the first through hole, wherein the light emitting element is fixed in the first through hole of the first substrate via the second adhesive layer; and
a third adhesive layer disposed in the second through hole, wherein the sensing element is fixed in the second through hole of the first substrate via the third adhesive layer.

8. The image capturing module according to claim 1, wherein the first circuit substrate further comprises a plurality of conductive columns and a first circuit layer, and the conductive columns penetrate the first substrate and the first circuit layer is located on a side of the first substrate that is away from the second circuit substrate and electrically connected with the conductive columns, and the second circuit substrate further comprises a second circuit layer that is located between the second substrate and the first circuit substrate and electrically connected with the first circuit layer via the conductive columns.

9. The image capturing module according to claim 8, wherein a conductive pad of the light emitting element is located on a side of the light emitting element that faces the second circuit substrate, and the conductive pad of the light emitting element is electrically connected with the first circuit layer via the second circuit layer and a first conductive column of the conductive columns, and a conductive pad of the sensing element is located on a side of the sensing element that faces the second circuit substrate, and the conductive pad of the sensing element is electrically connected with the first circuit layer via the second circuit layer and a second conductive column of the conductive columns.

10. The image capturing module according to claim 1, further comprising:
a first translucent protective layer disposed in the third through hole and covering the light emitting surface of the light emitting element.

11. The image capturing module according to claim 1, further comprising:
a second translucent protective layer disposed in the fourth through hole and covering the sensing surface of the sensing element.

12. A manufacturing method of an image capturing module, comprising:
forming a first through hole and a second through hole in a first substrate;
disposing a light emitting element in the first through hole;
disposing a sensing element in the second through hole;
forming a third through hole and a fourth through hole in a second substrate; and
disposing the second substrate on a side of the first substrate, wherein the third through hole overlaps the first through hole and exposes a light emitting surface of the light emitting element disposed in the first through hole, and the fourth through hole overlaps the second through hole and exposes a sensing surface of the sensing element disposed in the second through hole.

13. The manufacturing method of the image capturing module according to claim 12, wherein before disposing the light emitting element in the first through hole, the manufacturing method of the image capturing module further comprises:
making a thickness of the light emitting element equal to a thickness of the first substrate.

14. The manufacturing method of the image capturing module according to claim 12, wherein before disposing the sensing element in the second through hole, the manufacturing method of the image capturing module further comprises:
making a thickness of the sensing element equal to a thickness of the first substrate.

15. The manufacturing method of the image capturing module according to claim 12, wherein a method of disposing the second substrate on the side of the first substrate comprises bonding the first substrate and the second substrate via a first adhesive layer.

16. The manufacturing method of the image capturing module according to claim 12, wherein a method of disposing the light emitting element in the first through hole comprises fixing the light emitting element in the first through hole of the first substrate via a second adhesive layer, and a method of disposing the sensing element in the second through hole comprises fixing the sensing element in the second through hole of the first substrate via a third adhesive layer.

17. The manufacturing method of the image capturing module according to claim 12, wherein before disposing the second substrate on the side of the first substrate, the manufacturing method of the image capturing module further comprises:
forming a plurality of conductive columns in the first substrate and forming a first circuit layer electrically connected with the conductive columns on a side of the first substrate; and
forming a second circuit layer on a side of the second substrate,
wherein after disposing the second substrate on the side of the first substrate, the first substrate is located between the first circuit layer and the second circuit layer, and the second circuit layer is electrically connected with the first circuit layer via the conductive columns.

18. The manufacturing method of the image capturing module according to claim 17, wherein a method of disposing the light emitting element in the first through hole and disposing the sensing element in the second through hole comprises arranging a conductive pad of the light emitting element and a conductive pad of the sensing element to face the side of the first substrate where the second substrate is to be disposed,
wherein after disposing the second substrate on the side of the first substrate, the conductive pad of the light emitting element is electrically connected with the first circuit layer via the second circuit layer and a first conductive column of the conductive columns, and the conductive pad of the sensing element is electrically connected with the first circuit layer via the second circuit layer and a second conductive column of the conductive columns.

19. The manufacturing method of the image capturing module according to claim 12, wherein after disposing the second substrate on the side of the first substrate, the manufacturing method of the image capturing module further comprises:
disposing a first translucent protective layer in the third through hole, wherein the first translucent protective layer covers the light emitting surface of the light emitting element.

20. The manufacturing method of the image capturing module according to claim 12, wherein after disposing the second substrate on the side of the first substrate, the manufacturing method of the image capturing module further comprises:
disposing a second translucent protective layer in the fourth through hole, wherein the second translucent protective layer covers the sensing surface of the sensing element.
